(19) United States
(12) Patent Application Publication
(10) Pub. No.: US 2020/0065048 A1
(43) Pub. Date: Feb. 27, 2020

(54) INTEGRATED MULTI-MONITOR SETUP

(71) Applicant: International Business Machines Corporation, Armonk, NY (US)

(72) Inventors: Jorge Antonio Partida Meraz, Zapopan (MX); Carlos Andres Gutierrez Valdez, Guadalajara (MX)

(73) Assignee: International Business Machines Corporation, Armonk, NY (US)

(21) Appl. No.: 16/112,672

(22) Filed: Aug. 25, 2018

(51) Int. Cl. G06F 3/14; G06F 1/16

(52) U.S. Cl. CPC G06F 3/1446; G06F 3/1438; G06F 1/1649

(57) ABSTRACT

A method for implementing a multi-monitor setup in a computing system is disclosed. In one embodiment, such a method includes setting, in a primary monitor, configuration information for the primary monitor and one or more expansion monitors. The primary monitor then provides the configuration information to a computing system. The primary monitor receives, from the computing system, image information intended for the primary monitor and the one or more expansion monitors. The primary monitor displays image information that is intended specifically for the primary monitor and forwards, to the one or more expansion monitors, image information that is intended specifically for the one or more expansion monitors. A corresponding system and computer program product are also disclosed.

### BACKGROUND

### Field Of The Invention

This invention relates to systems and methods for implementing multiple monitors in a computing environment.

### Background Of The Invention

When it comes to establishing a more comfortable, efficient, and faster computing environment, the computer monitor may easily be the most important output device of a user's computer system. In a time when most computer components are getting smaller, many believe that bigger is better when it comes to monitors. A larger and higher resolution monitor can reduce eyestrain and increase productivity by allowing a user to view multiple applications simultaneously or view an entire document, spreadsheet, or image without needing to use directional arrows. For this reason, many individuals now build computer systems with multiple monitors. In addition, current operating systems frequently support multiple monitor setups, providing features such as seamless movement of mouse pointers between monitors and dragging windows from one monitor to another.

Unfortunately, multiple-monitor setups are not without their drawbacks and/or deficiencies. For example, such setups may require multiple internal video cards to be installed in a user's computer, or unsightly external equipment such as hubs, docking stations, video adapters, and cables. This may add additional clutter and complexity to a computing system. They may also place additional processing load on video cards or other processing components of the computing system. In some cases, video cards, graphical processing units (GPUs), or operating systems may not be configured to support the number of monitors needed or wanted by a user.

In view of the foregoing, what are needed are systems and methods to implement multi-monitor setups without requiring multiple internal or external video cards to be installed on a user's computer, or excessive amounts of unsightly external equipment. Ideally, such systems and methods will reduce clutter and complexity of a computing system.

### SUMMARY

The invention has been developed in response to the present state of the art and, in particular, in response to the problems and needs in the art that have not yet been fully solved by currently available systems and methods. Accordingly, systems and methods are disclosed to more efficiently and cleanly implement multi-monitor setups in computing systems. The features and advantages of the invention will become more fully apparent from the following description and appended claims, or may be learned by practice of the invention as set forth hereinafter.

Consistent with the foregoing, a method for implementing a multi-monitor setup in a computing system is disclosed. In one embodiment, such a method includes setting, in a primary monitor, configuration information for the primary monitor and one or more expansion monitors. The primary monitor then provides the configuration information to a computing system. The primary monitor receives, from the computing system, image information intended for the primary monitor and the one or more expansion monitors. The primary monitor displays image information that is intended specifically for the primary monitor and forwards, to the one or more expansion monitors, image information that is intended specifically for the one or more expansion monitors.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one example of a computing system for use with a multi-monitor setup in accordance with the invention;

FIG. 2 is a high-level block diagram showing an example of a conventional multi-monitor setup;

FIG. 3 is a high-level block diagram showing a first example of an improved multi-monitor setup in accordance with the invention;

FIG. 4 is a high-level block diagram showing connectors that may be integrated into edges of the monitors;

FIG. 5 is a high-level block diagram showing a second example of an improved multi-monitor setup in accordance with the invention;

FIG. 6 is a high-level block diagram showing a third example of an improved multi-monitor setup in accordance with the invention;

FIG. 7 is a high-level block diagram showing a fourth example of an improved multi-monitor setup in accordance with the invention; and

FIG. 8 is a high-level block diagram showing one embodiment of a configuration management module for implementation within a primary monitor.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

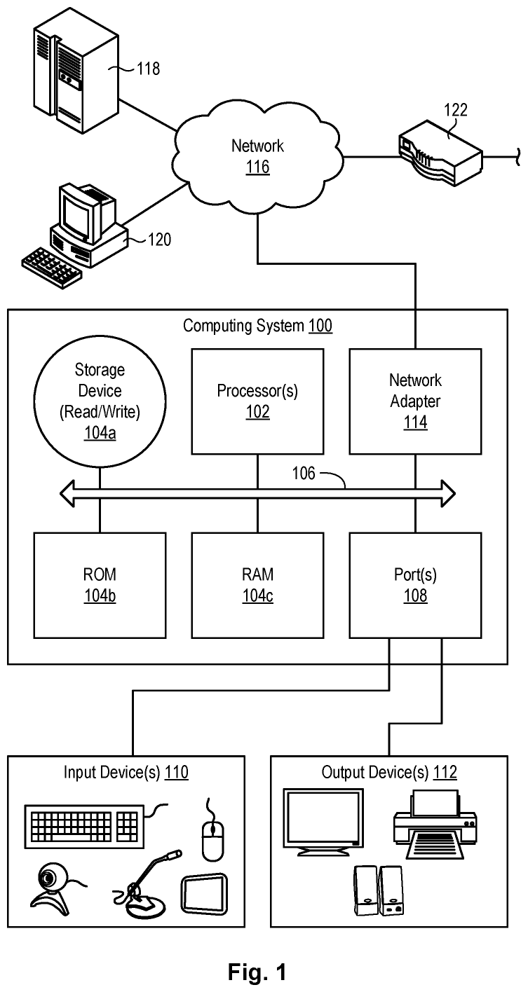

Referring to FIG. 1, one example of a computing system 100 is illustrated. The computing system 100 is presented to show one example of a computing system 100 for use with a multi-monitor setup in accordance with the invention. The computing system 100 may be embodied as a desktop computer, a workstation, a laptop computer, a server, a storage controller, a mobile device 100 such as a smart phone or tablet, or the like. The computing system 100 is presented by way of example and is not intended to be limiting. Indeed, the systems and methods disclosed herein may be applicable to a wide variety of different computing systems in addition to the computing system 100 shown. The systems and methods disclosed herein may also potentially be distributed across multiple computing systems 100.

As shown, the computing system 100 includes at least one processor 102 and may include more than one processor 102. The processor 102 may be operably connected to a memory 104. The memory 104 may include one or more non-volatile storage devices such as hard drives 104a, solid state drives 104a, CD-ROM drives 104a, DVD-ROM drives 104a, tape drives 104a, or the like. The memory 104 may also include non-volatile memory such as a read-only memory 104b (e.g., ROM, EPROM, EEPROM, and/or Flash ROM) or volatile memory such as a random access memory 104c (RAM or operational memory). A bus 106, or plurality of buses 106, may interconnect the processor 102, memory devices 104, and other devices to enable data and/or instructions to pass therebetween.

To enable communication with external systems or devices, the computing system 100 may include one or more ports 108. Such ports 108 may be embodied as wired ports 108 (e.g., USB ports, serial ports, Firewire ports, SCSI ports, parallel ports, etc.) or wireless ports 108 (e.g., Bluetooth, IrDA, etc.). The ports 108 may enable communication with one or more input devices 110 (e.g., keyboards, mice, touchscreens, cameras, microphones, scanners, storage devices, etc.) and output devices 112 (e.g., displays, monitors, speakers, printers, storage devices, etc.). The ports 108 may also enable communication with other computing systems 100.

In certain embodiments, the computing system 100 includes a wired or wireless network adapter 114 to connect the computing system 100 to a network 116, such as a local area network (LAN), wide area network (WAN), storage area network (SAN), or the Internet. Such a network 116 may enable the computing system 100 to connect to or communicate with one or more servers 118, workstations 120, personal computers 120, mobile computing devices, or other devices. The network 116 may also enable the computing system 100 to connect to or communicate with another network by way of a router 122 or other device 122. Such a router 122 may allow the computing system 100 to communicate with servers, workstations, personal computers, or other devices located on different networks.

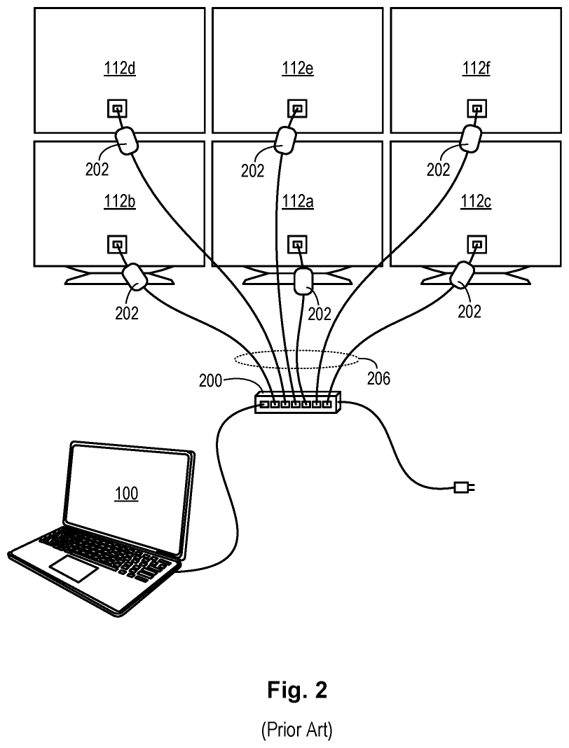

Referring to FIG. 2, as previously mentioned, in order to provide a more comfortable, efficient, and faster computing environment, the computer monitor 112 may be the most important, or one of the most important, output devices of a user's computer system. A larger and higher resolution monitor 112 may reduce eyestrain and increase productivity by allowing a user to view multiple applications simultaneously or view an entire document, spreadsheet, or image without needing to use directional arrows. For this reason, many individuals build computing systems 100 with multiple monitors 112. In addition, current operating systems frequently provide support for multiple monitor setups, providing features such as seamless movement of mouse pointers between monitors 112 and dragging windows from one monitor 112 to another.

Unfortunately, multiple-monitor setups are not without their drawbacks and/or deficiencies. For example, such setups may require multiple internal or external video cards to be installed in a user's computer, or unsightly external equipment such as hubs 200, docking stations, video adapters 202, and cables 206, as shown in FIG. 2. This may add additional clutter and complexity to a computing system 100. They may also place additional processing load on video cards or other processing components of the computing system 100. In some cases, video cards, graphical processing units (GPUs), or operating systems may not be configured to support the number of monitors 112 needed or wanted by a user.

In view of the foregoing, systems and methods are needed to implement multi-monitor setups without requiring multiple internal or external video cards to be installed on a user's computing system 100, or excessive amounts of unsightly external equipment such as hubs 200, docking stations, video adapters 202, and cables 206. Ideally, such systems and methods will reduce clutter and complexity of a computing system 100, as well as reduce processing loads on video cards or other processing components of the computing system 100.

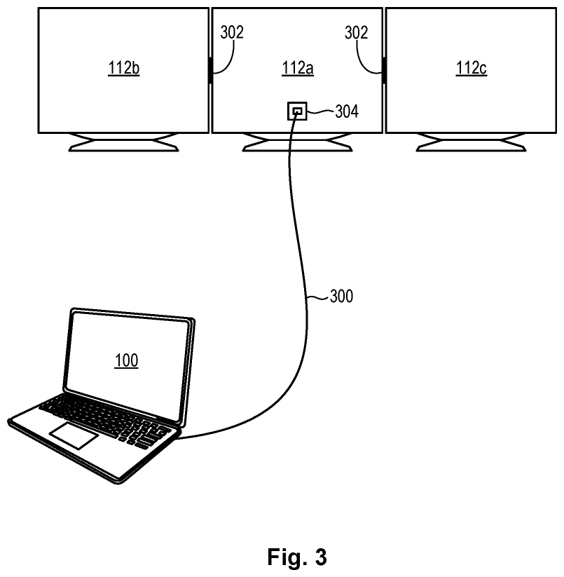

Referring to FIG. 3, one embodiment of an improved multi-monitor setup in accordance with the invention is illustrated. As shown, instead of using multiple internal or external video cards, or excessive external equipment, a hub and spoke topology may used where a primary monitor 112a acts as a hub for other expansion monitors 112b, 112c. As shown, a computing system 100, such as the illustrated laptop computing system 100, may connect to the primary monitor 112a. The computing system 100 may transmit image and video data to the primary monitor 112a. The primary monitor 112a may display image and video data that is intended specifically for the primary monitor and forward, to the expansion monitors 112b, 112c, image and video data intended specifically for the expansion monitors 112b, 112c. In the illustrated embodiment, a single cable 300 may connect the computing system 100 to the primary monitor 112a through a port 304 in the primary monitor 112a. In other embodiments, such as with all-in-on computers 100, no cable 300 may be needed since the computing system 100 and primary monitor 112a may be integrated.

As shown in FIG. 3, in order to implement a multi-monitor setup, one or more expansion monitors 112b, 112c may be connected to the primary monitor 112a. In certain embodiments, no additional cables are needed to connect the expansion monitors 112b, 112c to the primary monitor 112a. Rather, connectors 302 may be integrated into edges of the primary monitor 112a and expansion monitors 112b, 112c. The monitors 112a-c may be connected together by abutting their edges together. If needed, the height of the monitors 112a-c may be adjusted to align the connectors 302. Alternatively or additionally, the connectors 302 may slide or move along the edges of the monitors 112 to align them with connectors 302 of adjacent monitors 112. In certain embodiments, connecting two monitor 112 by way of the connectors 302 may extend a communication bus for transmitting image and/or video data.

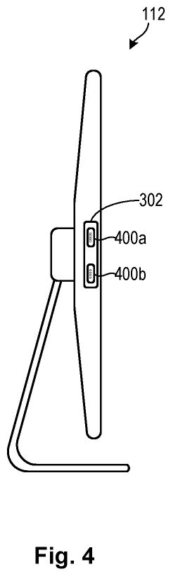

Referring to FIG. 4, in certain embodiments, a connector 302 may include an input port 400a, for receiving image and/or video data, and an output port 400b, for transmitting image and/or video data. The input and output ports 400a, 400b may be embodied as separate ports or integrated into a single port. Various different types of connectors may be used, such as USB, HDMI, DisplayPort, Thunderbolt, VGA, DVI, and similar connectors. In certain embodiments, the connectors 302 may pivot or flex relative to the edges of the monitors 112 to enable multiple monitors 112 to be angled relative to one another. Thus, in certain embodiments, the connectors 302 are flexibly attached to a monitor 112 or provide a pivoting or flexible connection with one another.

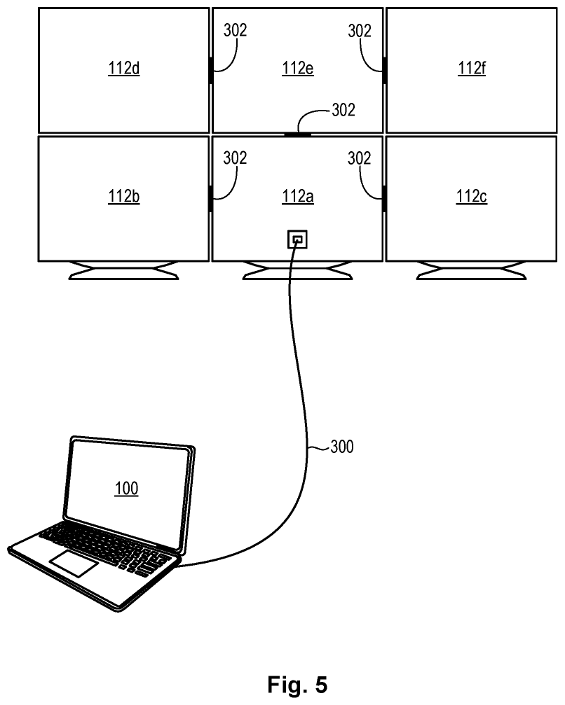

Referring to FIG. 5, the connectors 302 discussed above may be utilized to create different arrangements of monitors 112. For example, connectors 302 may be placed on the top or bottom of monitors 112 to enable vertical stacking of monitors 112. As shown in FIG. 5, a connector 302 placed at the top of the primary monitor 112a is used to connect to the expansion monitor 112e. This expansion monitor 112e may, in turn, connect to expansion monitors 112d, 112f to transfer image and/or video data thereto.

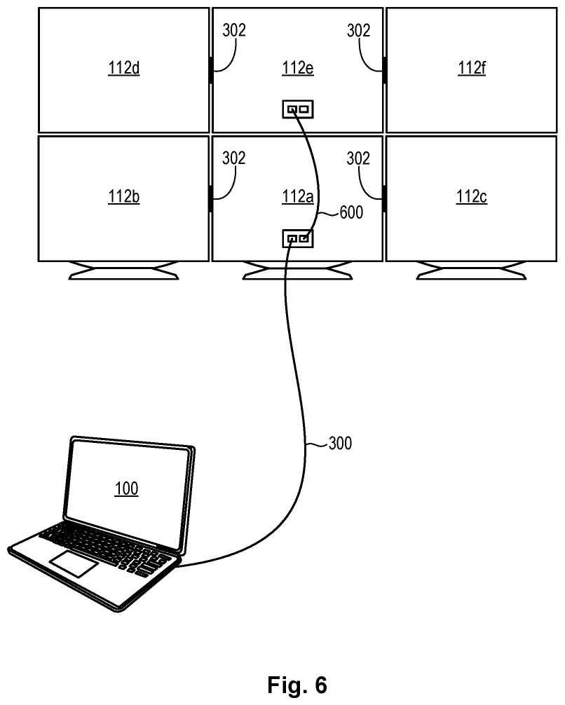

Alternatively, a second cable 600 may be used to connect the primary monitor 112a to the upper expansion monitor 112e, as shown in FIG. 6. The upper expansion monitor 112e may then use the edge-based connectors 302 to connect to other expansion monitors 112d, 112f. Thus, in certain embodiments, a combination of cables and connectors 302 may be used to provide a multi-monitor setup in accordance with the invention. Different configurations using cables 600 and/or edge-based connectors 302 are possible and within the scope of the invention.

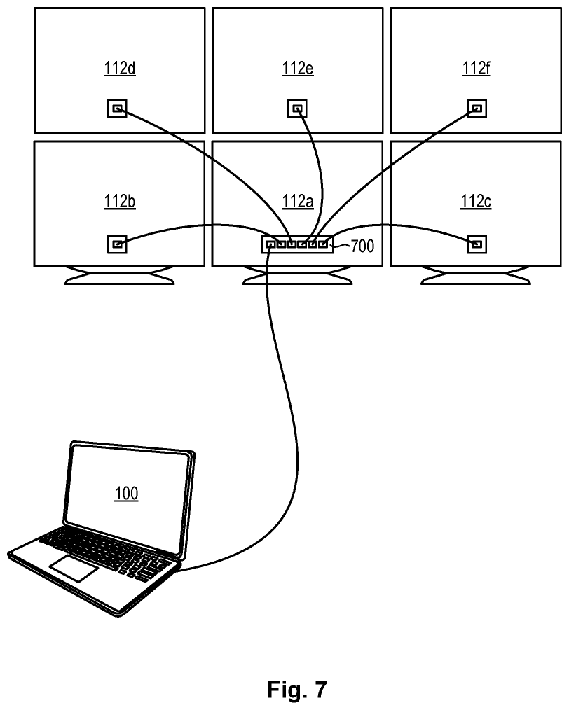

Referring to FIG. 7, in other embodiment in accordance with the invention, the primary monitor 112a may act as a hub and the expansion monitors 112b-f may connect to the hub with cables. The primary monitor 112a may be equipped with multiple output ports 700 to accommodate multiple expansion monitors 112b-f. This may significantly reduce clutter and cabling compared to the conventional configuration shown in FIG. 2. If required video adapters 202 (e.g., DisplayPort to HDMI, HDMI to VGA, USB to HDMI/VGA/DVI, etc., may be inserted between the primary monitor 112a and the expansion monitors 112b-f, depending on the communication technology used to relay image and video data from the primary monitor 112a to the expansion monitors 112b-f, and the type and physical configuration of the expansion monitors 112. The embodiment illustrated in FIG. 7 may be advantageous in that legacy expansion monitors 112b-f may be used with the primary monitor 112a without needing updated edge-based connectors 302.

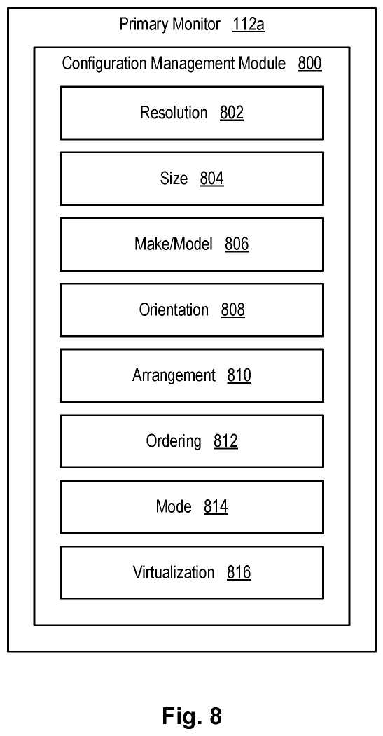

Referring to FIG. 8, in certain embodiments, the primary monitor 112a may be configured manage the configuration of the primary monitor 112a as well as expansion monitors 112b-f connected thereto. In certain embodiments, this functionality may be provided by a configuration management module 800 within the primary monitor 112a. This configuration management module 800 may manage various configuration settings or parameters for the primary monitor 112a and expansion monitors 112b-f (collectively referred to as a “cluster”). These configuration settings or parameters may be gathered from the primary monitor 112a and/or expansion monitors 112b-f, set or modified by a user through the primary monitor 112a itself (such as using a touchscreen, buttons, or other controls of the primary monitor 112a), or set or modified by a user through a computing system 100 or console coupled to the primary monitor 112a. In certain embodiments, each of these settings or parameters may be discovered or queried by a computing system 100 coupled to the primary monitor 112a.

As shown, the configuration management module 800 may determine and/or store a resolution 802 for each monitor 112 in a cluster, a size 804 (e.g., diagonal or rectangular dimensions) of each monitor 112 in a cluster, make/model 806 for each monitor 112 in a cluster, as well as other inherent attributes of each monitor 112 in a cluster. The configuration management module 800 may also determine and/or store, by user input or other means, an orientation 808 (e.g., landscape, portrait, etc.) for each monitor 112 in a cluster, as well as the arrangement 810 of each monitor 112 in the cluster. The arrangement 810 may indicate the relative placement of monitors 112 with respect to one another, such as indicate whether they are side-by-side, stacked on top of one another, placed in a grid pattern, etc. The configuration management module 800 may also indicate the ordering 812 of monitors 112 in the cluster (e.g., which monitor 112 is monitor 1, monitor 2, monitor 3, monitor 4, etc.).

In certain embodiments, the configuration management module 800 may also establish a mode 814 for the cluster. These modes 814 may include, for example, a mirror mode wherein the same image or video is duplicated across all monitors 112 in a cluster, an extended desktop mode wherein the monitors 112 are used to extend a useable desktop area, and/or a wall mode wherein images and/or videos are split across the monitors 112 as if the monitors 112 were one large screen.

The configuration management module 800 may also facilitate virtualization 816 such that the configuration management module 800 may make different monitors 112 appear, to a connected computing system 100, to be different than the underlying physical hardware. For example, the configuration management module 800 may make a group of monitors 112 appear to be a single monitor (e.g., presenting the resolution of multiple monitors 112 as one large virtualized monitor 112 with a combined resolution) or smaller number of monitors 112, or the configuration management module 800 may divide up the screen space of a single monitor 112 and make it appear to be multiple monitors 112 (e.g., dividing the available resolution of a single monitor 112 into multiple resolutions each useable as an individual virtualized monitor 112). The operating system of the computing system 100 may detect and recognize virtualized monitors as defined in the primary monitor 112a. Other types of virtualization are also possible and within the scope of the invention.

As set forth above, various different communication technologies and/or interfaces may be used to enable communication between the computing system 100 and the primary monitor 112a, and between the primary monitor 112a and the expansion monitors 112b-f. In one embodiment, Universal Serial Bus (USB), such as USB version 3.0, is used to transport image and/or video signals between the devices 100, 112. In other embodiments, communication technologies and/or interfaces such as HDMI, DisplayPort, Thunderbolt, DVI, VGA may be used to transfer image and/or video data between the devices 100, 112.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for implementing a multi-monitor setup in a computing system, the method comprising:
receiving, by a primary monitor from a computing system, image information intended for the primary monitor and at least one expansion monitor;
displaying, on the primary monitor, image information intended specifically for the primary monitor; and
forwarding image information intended specifically for the at least one expansion monitor, from the primary monitor to the at least one expansion monitor through connectors integrated into adjacent edges of the primary monitor and the at least one expansion monitor, wherein the connectors connect the primary monitor to the at least one expansion monitor by abutting the adjacent edges together.

2. The method of claim 1, further comprising:
setting, in the primary monitor, configuration information for the primary monitor and the at least one expansion monitor; and
providing, by the primary monitor to the computing system, the configuration information.

3. The method of claim 2, wherein the configuration information includes information describing a physical arrangement of the primary monitor and the at least one expansion monitor.

4. The method of claim 1, wherein the primary monitor and the at least one expansion monitor are daisy chained together.

5. The method of claim 1, wherein each expansion monitor is directly connected to the primary monitor.

6. The method of claim 1, wherein forwarding the image information comprises forwarding the image information through a hub incorporated into the primary monitor.

7. The method of claim 24, wherein the configuration information indicates whether to present, to the computing system, the primary monitor and the at least one expansion monitor as individual monitors or as a single monitor.

8. A computer program product for implementing a multi-monitor setup in a computing system, the computer program product comprising a computer-readable storage medium having computer-usable program code embodied therein, the computer-usable program code configured to perform the following when executed by at least one processor:
receive, by a primary monitor from a computing system, image information intended for the primary monitor and at least one expansion monitor;
display, on the primary monitor, image information intended specifically for the primary monitor; and
forward image information intended specifically for the at least one expansion monitor, from the primary monitor to the at least one expansion monitor through connectors integrated into adjacent edges of the primary monitor and the at least one expansion monitor, wherein the connectors connect the primary monitor to the at least one expansion monitor by abutting the adjacent edges together, image information intended specifically for the at least one expansion monitor.

9. The computer program product of claim 8, wherein the computer-usable program code is further configured to:
set, in the primary monitor, configuration information for the primary monitor and the at least one expansion monitor; and
provide the configuration information from the primary monitor to the computing system.

10. The computer program product of claim 9, wherein the configuration information includes information describing a physical arrangement of the primary monitor and the at least one expansion monitor.

11. The computer program product of claim 8, wherein the primary monitor and the at least one expansion monitor are daisy chained together.

12. The computer program product of claim 8, wherein each expansion monitor is directly connected to the primary monitor.

13. The computer program product of claim 8, wherein forwarding the image information comprises forwarding the image information through a hub incorporated into the primary monitor.

14. The computer program product of claim 9, wherein the configuration information indicates whether to present, to the computing system, the primary monitor and the at least one expansion monitor as individual monitors or as a single monitor.

15. A system for implementing a multi-monitor setup in a computing system, the system comprising:
at least one processor;
at least one memory device operably coupled to the at least one processor and storing instructions for execution on the at least one processor, the instructions causing the at least one processor to:
receive, by a primary monitor from a computing system, image information intended for the primary monitor and at least one expansion monitor;
display, on the primary monitor, image information intended specifically for the primary monitor; and
forward image information intended specifically for the at least one expansion monitor from the primary monitor to the at least one expansion monitor through connectors integrated into adjacent edges of the primary monitor and the at least one expansion monitor, wherein the connectors connect the primary monitor to the at least one expansion monitor by abutting the adjacent edges together.

16. The system of claim 15, wherein the instructions further cause the at least one processor to:
set, in the primary monitor, configuration information for the primary monitor and the at least one expansion monitor; and
provide the configuration information from the primary monitor to the computing system.

17. The system of claim 16, wherein the configuration information includes information describing a physical arrangement of the primary monitor and the at least one expansion monitor.

18. The system of claim 15, wherein the primary monitor and the at least one expansion monitor are daisy chained together.

19. The system of claim 15, wherein each expansion monitor is directly connected to the primary monitor.

20. The system of claim 16 15, wherein the configuration information indicates whether to present, to the computing system, the primary monitor and the at least one expansion monitor as individual monitors or as a single monitor.
